(19) United States
(12) Patent Application Publication
(10) Pub. No.: US 2026/0230338 A1
(43) Pub. Date: Aug. 6, 2026

(54) BAGGING AND UNBAGGING BLOCKCHAIN ASSETS

(71) Applicant: Richard Chung, Corona, CA (US)

(72) Inventor: Richard Chung, Corona, CA (US)

(21) Appl. No.: 19/045,611

(22) Filed: Feb. 5, 2025

(51) Int. Cl. H04L 9/00; H04L 9/08; H04L 9/32

(52) U.S. Cl. CPC H04L 9/50; H04L 9/0825; H04L 9/0863; H04L 9/0869; H04L 9/3236; H04L 9/3247

(57) ABSTRACT

Trustless management of blockchain assets using multi-factor authentication includes a blockchain smart contract for minting bag NFTs that represent ownership of blockchain assets and a zero-trust backend server that manages cryptographic keys and enforces two-factor authentication. When bagging an asset, the system generates a public-private key pair, encrypts and stores the private key fraction in a secure key management service, and associates the public key with a bag NFT on the blockchain. To unbag an asset, the user must provide a valid two-factor authentication code to decrypt the private key fraction, which is then combined with a wallet signature to reconstruct the full private key for signing the unbag transaction. The smart contract verifies the signature and bag NFT ownership before releasing assets. By splitting custody between the blockchain wallet and an external key, the system provides enhanced security against unauthorized access or theft of assets.

### BACKGROUND

In the field of blockchain technology and digital asset management, secure custody and management of digital assets is critical to ensuring protection against unauthorized access and theft. Robust security measures are essential to prevent asset loss and to comply with evolving regulatory requirements. Inadequate security protocols can lead to devastating financial losses and erosion of user trust. Therefore, a reliable and accurate digital asset custody system is indispensable for businesses such as cryptocurrency exchanges, digital asset funds, and blockchain-based platforms.

In a typical blockchain ecosystem, users often rely on single private key systems to secure their digital assets. These systems present a significant vulnerability, as the compromise of a single private key can result in complete loss of all associated assets. For example, if a malicious actor gains access to a user's private key, they can potentially transfer all the user's cryptocurrencies and non-fungible tokens (“NFTs”) to their own wallet, leaving the original owner with no recourse. Even cold storage wallets are not entirely immune to risks, as they typically operate as single private key systems reliant on seed phrases. If a seed phrase is compromised, an attacker can bypass all security measures of the cold storage wallet.

When entities manage multiple types of digital assets across various blockchain networks, it can be difficult to maintain consistent security standards and streamline asset management processes. For example, users may need to interact with multiple wallets, smart contracts, and security protocols to manage different asset types, increasing complexity and the potential for errors. This process adds significant cognitive load to users and asset managers. Meanwhile, the rapid evolution of blockchain technology and the emergence of new asset types create ongoing challenges for implementing comprehensive security measures.

The rapid evolution of blockchain technology and the emergence of new asset types have led to increasingly complex digital asset management requirements. Users and institutions often need to interact with multiple wallets, smart contracts, and security protocols to manage different asset types across various blockchain networks. This complexity increases the potential for errors and security vulnerabilities. Current security systems typically operate on a per-wallet basis, leaving users unable to apply different security schemes to different assets held within the same wallet.

The growing threat of quantum computing adds another layer of complexity to digital asset security. As quantum computers become more powerful, they may potentially break current cryptographic standards used in blockchain technology. This looming threat necessitates the development of more robust and adaptable security measures for digital asset custody.

As a result, a need exists for improved systems and methods for secure digital asset custody and management in blockchain environments. In addition, a need exists for a flexible and user-friendly solution that allows for the consolidation of diverse digital assets under a single security framework while maintaining robust protection against unauthorized access and potential quantum computing threats.

### SUMMARY

Examples described herein include a method for trustless management of a blockchain asset.

An example method for trustless management of a blockchain asset can include receiving a user selection of a blockchain asset in a wallet. The example method can include receiving a wallet signature key fraction associated with the wallet. In the example method, a random time-based, one-time password (“TOTP”) key fraction is generated. A TOTP secret can be generated based on the wallet signature key fraction and the TOTP key fraction. The TOTP secret is transmitted to a user device of the user. The example method can further include generating a random key fraction. A public-private key pair can be generated based on the wallet signature and the random key fraction. The example method can include invoking a smart contract on a blockchain. The smart contract can mint a bag NFT to the wallet, where the bag NFT represents ownership of the blockchain asset. As part of this process, the smart contract can generate a random nonce variable. The smart contract can also generate a bag NFT ID, wherein the bag NFT ID can be mapped to a public key of the public-private key pair and a random nonce variable. The smart contract allows for the BVGS NFT owner to continuously bag and deposit blockchain assets to the bag NFT. BVGS NFT deposits are restricted to BVGS NFT owners only.

Another example method for trustless management of a blockchain asset can include receiving a request to unbag the blockchain asset using the bag NFT. The example unbagging method can include receiving a wallet signature key fraction associated with the wallet. The TOTP key fraction associated with the wallet can be decrypted, and the TOTP secret can be generated using the wallet signature key fraction and the decrypted TOTP key fraction. A code provided by the user can be validated using the new TOTP secret. The example method can also include decrypting the key fraction associated with the bag NFT ID. A private key from the public-private key pair can be generated based on the wallet signature key fraction and stored random key fraction. As part of the example method, a message that includes the bag NFT ID, public key, and the random nonce variable can be generated. The generated message can be signed using the private key. The method can further include invoking a smart contract on a blockchain, such as the smart contract used to bag the asset. The smart contract can validate that the message originates from the owner of the bag NFT and verify the signed message. The smart contract can unbag the blockchain asset from the bag NFT. The method can further include sending, by the smart contract, the blockchain asset to a recipient.

In another example, a server system includes a hardware-based processor and a memory storing non-transitory, computer-readable instructions. When executed by the processor, the instructions can cause the server system to perform any or all of the relevant method stages described above and herein. For example, the server system can generate a TOTP secret based on the wallet signature key fraction and the TOTP key fraction. The example system can transmit the TOTP secret to a user device of the user. A random key fraction can also be generated by the server system. A public-private key pair can be generated based on the wallet signature and the random key fraction. The server system can invoke a smart contract on a blockchain. The smart contract can mint a bag non-fungible token (NFT) to the wallet, where the bag NFT represents ownership of the blockchain asset. The smart contract can generate a bag NFT ID, wherein the bag NFT ID can be mapped to a public key of the public-private key pair and a random nonce variable.

Both the foregoing general description and the following detailed description are exemplary and explanatory only and are not restrictive of the examples, as claimed.

### BRIEF DESCRIPTION OF THE DRAWINGS

FIG. 1 is a schematic diagram of an example system architecture for trustless management of blockchain assets according to one or more embodiments herein.

FIG. 2 is a flowchart of an example method for bagging a blockchain asset according to one or more embodiments herein.

FIG. 3 is a flowchart of an example method for unbagging a blockchain asset using a bag NFT according to one or more embodiments herein.

FIG. 4 is a partial flow diagram illustrating interactions between system components for minting a bag NFT according to one or more embodiments herein.

FIG. 4 (CONT'D) is a continuation of the partial flow diagram of FIG. 4.

FIG. 5 is a partial flow diagram illustrating interactions between system components for minting a bag NFT according to one or more embodiments herein.

FIG. 5 (CONT'D) is a continuation of the partial flow diagram of FIG. 5.

FIG. 5 (CONT'D)1 is a continuation of the partial flow diagrams of FIGS. 5 and 5 (CONT'D).

FIG. 6 is a partial flow diagram illustrating interactions between system components for unbagging a blockchain asset according to one or more embodiments herein.

FIG. 6 (CONT'D) is a continuation of the partial flow diagram of FIG. 6.

FIG. 7 is a partial flow diagram illustrating interactions between system components for unbagging a blockchain asset according to one or more embodiments herein.

FIG. 7 (CONT'D) is a continuation of the partial flow diagram of FIG. 7.

FIG. 7 (CONT'D)1 is a continuation of the partial flow diagrams of FIGS. 7 and 7 (CONT'D).

FIG. 7 (CONT'D)2 is a continuation of the partial flow diagrams of FIGS. 7, 7 (CONT'D), and 7 (CONT'D)1.

FIG. 7 (CONT'D)3 is a continuation of the partial flow diagrams of FIGS. 7, 7 (CONT'D), 7 (CONT'D)1, and 7 (CONT'D)2.

FIG. 7 (CONT'D)4 is a continuation of the partial flow diagrams of FIGS. 7, 7 (CONT'D), 7 (CONT'D)1, 7 (CONT'D)2, and 7 (CONT'D)3.

### DETAILED DESCRIPTION

Reference will now be made in detail to the present examples, including examples illustrated in the accompanying drawings.

A system and method for trustless management of blockchain assets using multi-factor authentication is disclosed. The system includes a blockchain smart contract for minting NFTs that represent ownership of blockchain assets, and a zero-trust backend server that manages cryptographic keys and enforces two-factor authentication. When bagging an asset, the system generates a public-private key pair, encrypts and stores the private key fraction in a secure key management service, and associates the public key with a bag NFT on the blockchain. To unbag an asset, the user must provide a valid two-factor authentication code to decrypt the private key fraction, which is then combined with a wallet signature to reconstruct the full private key for signing the unbag transaction. The smart contract verifies the signature and bag NFT ownership before releasing assets. By splitting custody between the blockchain and an external key, the system provides enhanced security against unauthorized access or theft of assets.

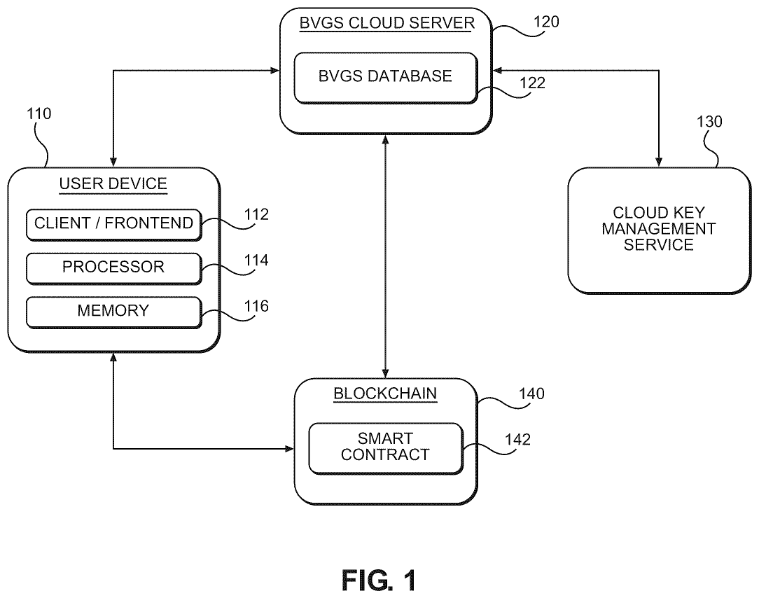

FIG. 1 illustrates an example system architecture 100 for implementing a trustless two-factor-authentication secured system for decentralized asset management and, for example, performing the various methods described herein. The system of FIG. 1 includes a user device 110, a BVGS cloud server 120, a cloud key management service 130, and a blockchain 140.

The user device 110 may be any suitable computing device such as a smartphone, tablet, laptop computer, desktop computer, or other device capable of connecting to a network and interacting with the BVGS system. The user device 110 includes a client/frontend component 112 that provides a user interface for interacting with the BVGS system. The client/frontend 112 may be implemented as a web application, mobile app, or other suitable interface. The user device 110 also includes a processor 114 and memory 116 for executing instructions and storing data related to the BVGS system.

The BVGS cloud server 120 implements the backend logic and data management for the BVGS system. The cloud server 120 includes a BVGS database 122 for storing user data, asset metadata, encrypted key fractions, and other information used by the system. The cloud server 120 may be implemented using cloud computing infrastructure to provide scalability and reliability. For example, the cloud server 120 can be a single server or a group of multiple servers working in conjunction with one another to provide server functionality. Alternatively, since bagged asset metadata is inherently stored within the blockchain and tracked with the BVGS smart contract, bagged asset metadata can instead be retrieved on-chain through smart contract enforced token ownership validation, removing the need to store bagged asset metadata within a cloud database. Backend logic and data management can also be deployed and hosted on an on-premise environment through edge servers or data center server racks.

The cloud key management service 130 provides secure storage and management of cryptographic keys used by the BVGS system. The key management service 130 may be a dedicated key management system that adheres to security standards such as FIPS 140-2 and FIPS 140-3. It enables secure generation, storage, and usage of encryption keys while preventing unauthorized access.

The blockchain 140 represents one or more blockchain networks that the BVGS system interacts with to manage digital assets. The blockchain 140 includes smart contracts 142 that implement the on-chain logic for the BVGS system, such as minting and managing BVGS NFTs (also generically referred to herein as “bag NFTs”). The blockchain 140 may be any suitable blockchain platform that supports smart contracts, such as Ethereum, Binance Smart Chain, Polygon, or others. The smart contracts 142 can define rules for minting, transferring, and burning NFTs that represent ownership of blockchain assets.

In operation, a user interacts with the BVGS system via the client/frontend 112 on their user device 110. The client communicates with the BVGS cloud server 120 to initiate actions such as connecting a wallet, bagging assets, or unbagging assets. The cloud server 120 coordinates with the key management service 130 to securely manage cryptographic keys. When blockchain transactions are required, the cloud server 120 interacts with the smart contracts 142 deployed on the blockchain 140 to execute on-chain operations.

This distributed architecture provides multiple layers of security while maintaining a trustless system where no single entity has complete control over a user's assets. The use of two-factor authentication, encrypted key fractions, and blockchain-based ownership records creates a robust system for managing decentralized assets.

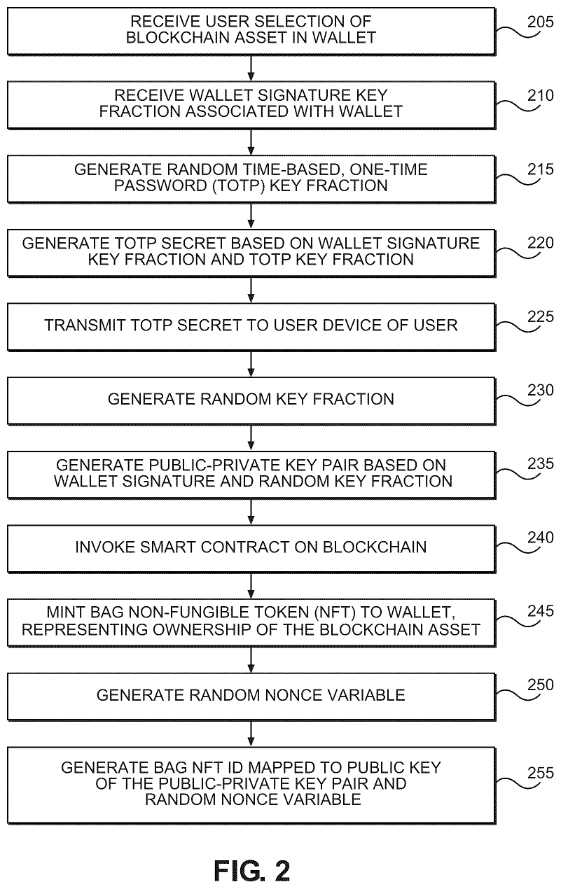

FIG. 2 illustrates an example method for generating a bag NFT representing ownership of a blockchain asset. The method can be performed by a server system, such as the BVGS cloud server 120 shown in FIG. 1.

At stage 205, the example method can include receiving a user selection of a blockchain asset in a wallet. For example, the server system can receive an indication from a user device that the user has selected a particular cryptocurrency token, fungible token, or non-fungible token from their blockchain wallet to be bagged into a BVGS NFT.

At stage 210, the example method can include receiving a wallet signature key fraction associated with the wallet. As used herein, the term “key fraction” can be understood to be a portion of a key, including potentially an encrypted portion of a key or a portion of an encrypted key. In an example, this stage includes receiving a signed message from the user's wallet that includes a portion of the wallet's private key or other data through which the wallet signature key fraction can be derived.

At stage 215, the example method can include generating a random time-based, one-time password (TOTP) key fraction. The TOTP key fraction can be a portion of a TOTP key in an example. In an example, the TOTP key fraction can be used as part of a two-factor authentication process.

At stage 220, the example method can include generating a TOTP secret based on the wallet signature key fraction and the TOTP key fraction. For example, the server system can combine or hash together the wallet signature key fraction and TOTP key fraction to produce a unique TOTP secret for the user.

At stage 225, the example method can include transmitting the TOTP secret to a user device of the user. In an example, this can involve sending a QR code containing the TOTP secret or sending the secret itself to the user's device for scanning into an authenticator app. However, any other known transmission methods can be used to provide a temporary code containing the TOTP secret to the user's device.

At stage 230, the example method can include generating a random key fraction. This stage can be performed by a server, such as the BVGS cloud server 120 of FIG. 1. The random key fraction can be used as part of generating a public-private key pair for the BVGS NFT at stage 235. Specifically, the method can include generating a public-private key pair based on the wallet signature and the random key fraction. For example, the server system can combine the wallet signature with the random key fraction to deterministically generate a unique public-private key pair for the BVGS NFT.

At stage 240, the example method can include invoking a smart contract on a blockchain. In some examples, this stage also includes deploying a smart contract on a blockchain, to the extent the smart contract has not already been deployed. Deploying the smart contract can include uploading and storing code corresponding to the smart contract to the blockchain. Invoking the smart contract can include calling a function of the smart contract and/or sending a transaction to the smart contract. This smart contract can handle the bagging and unbagging processes relating to the underlying blockchain asset.

At stage 245, the example method can include minting a bag NFT to the wallet, wherein the bag NFT represents ownership of the blockchain asset. At this stage, the smart contract can mint a new BVGS NFT and associate it with the user's wallet address in the manner described herein. The smart contract allows for the BVGS NFT owner to continuously bag and deposit blockchain assets to the bag NFT. BVGS NFT deposits are restricted to BVGS NFT owners only.

At stage 250, the example method can include generating a random nonce variable. The random nonce variable can be a number, letter, character, or string of numbers, letters, and/or other characters. This nonce variable can be used to prevent replay attacks when interacting with the BVGS NFT as explained in more detail herein.

At stage 255, the example method can include generating a bag NFT ID mapped to a public key of the public-private key pair and the random nonce variable. The bag NFT ID can be any type of identifier capable of being stored at the server or on the blockchain. This mapping links the BVGS NFT to its associated public key and nonce for future verification.

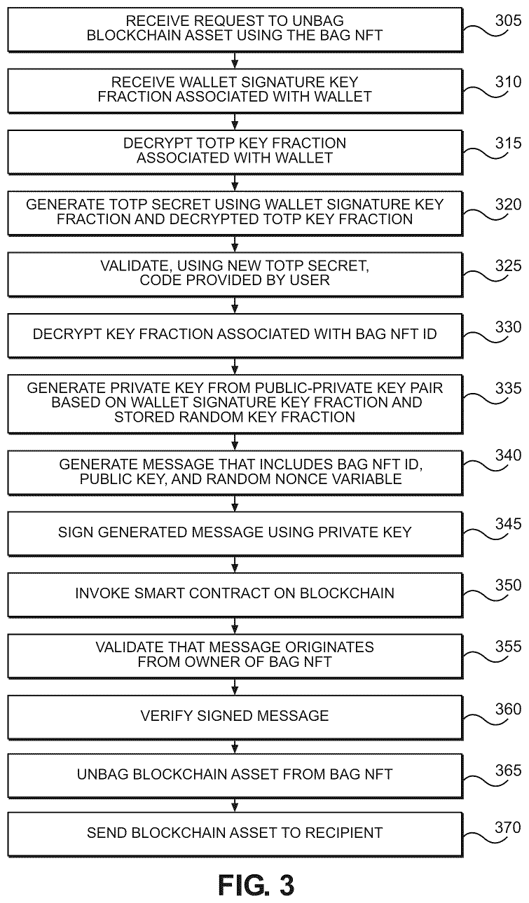

FIG. 3 illustrates an example method for unbagging a blockchain asset using a bag NFT. In an example, the method can be performed by a server system, such as the BVGS cloud server 120 shown in FIG. 1.

At stage 305, the server system can receive a request to unbag a blockchain asset using the bag NFT. For example, a user may initiate an unbag request through a client application on their device to withdraw an asset that was previously bagged into a BVGS NFT as described with respect to FIG. 2.

At stage 310 of the example method, the server system can receive a wallet signature key fraction associated with the user's wallet. In an example, this can include requesting the user to sign a message with their wallet private key to derive the wallet signature key fraction.

At stage 315, the server system can decrypt a TOTP key fraction associated with the wallet. The TOTP key fraction may have been previously encrypted and stored securely, such as in a cloud key management service as described previously. At stage 320, the server system can generate a TOTP secret using the wallet signature key fraction received in stage 310 and the decrypted TOTP key fraction from stage 315. This reconstructs the full TOTP secret needed for two-factor authentication.

At stage 325 of the example method, the server system can validate a code provided by the user using the generated TOTP secret. For example, the user may be prompted to enter a 6-digit code from their authenticator app, which the server then verifies against the reconstructed TOTP secret.

At stage 330, after successful TOTP validation, the server system can decrypt a key fraction associated with the bag NFT ID. This key fraction may also have been previously encrypted and securely stored, such as in a cloud key management service as described in examples above. At stage 335, the server system can generate a private key from a public-private key pair. This private key can be generated based on the wallet signature key fraction received in stage 310 and the stored random key fraction decrypted in stage 330.

At stage 340 of the example method, the server system can generate a message that includes the bag NFT ID, a public key corresponding to the generated private key, and a random nonce variable associated with the bag NFT. This message includes data needed for on-chain verification.

At stage 345, the server system can sign the message generated at stage 340 using the private key reconstructed in stage 335. This creates a cryptographic signature proving authorization to unbag the asset.

At stage 350, the server system can invoke a smart contract on the blockchain to initiate the unbagging process. In this example, invoking the smart contract includes providing the signed message and other necessary data to the smart contract. It can also include providing a transaction request to the smart contract.

At stage 355, the smart contract can validate that the message originates from the owner of the bag NFT. This stage can include checking that the public key in the message matches the one associated with the bag NFT on-chain.

At stage 360 of the example method, the smart contract can verify the signed message using the public key to ensure the signature is valid and the message has not been tampered with. At stage 365, if all verifications pass, the smart contract can unbag the blockchain asset from the bag NFT. This releases the asset from its locked state within the BVGS NFT.

Finally, at stage 370, the smart contract can send the unbagged blockchain asset to a recipient. The recipient may be the original owner's wallet or another address specified in the unbag request.

In some examples, additional stages may be performed, such as burning the empty bag NFT after successful unbagging or regenerating a new nonce variable to prevent replay attacks. The example method of FIG. 3 provides a secure way to withdraw assets from a BVGS NFT by combining off-chain cryptographic operations with on-chain smart contract verification.

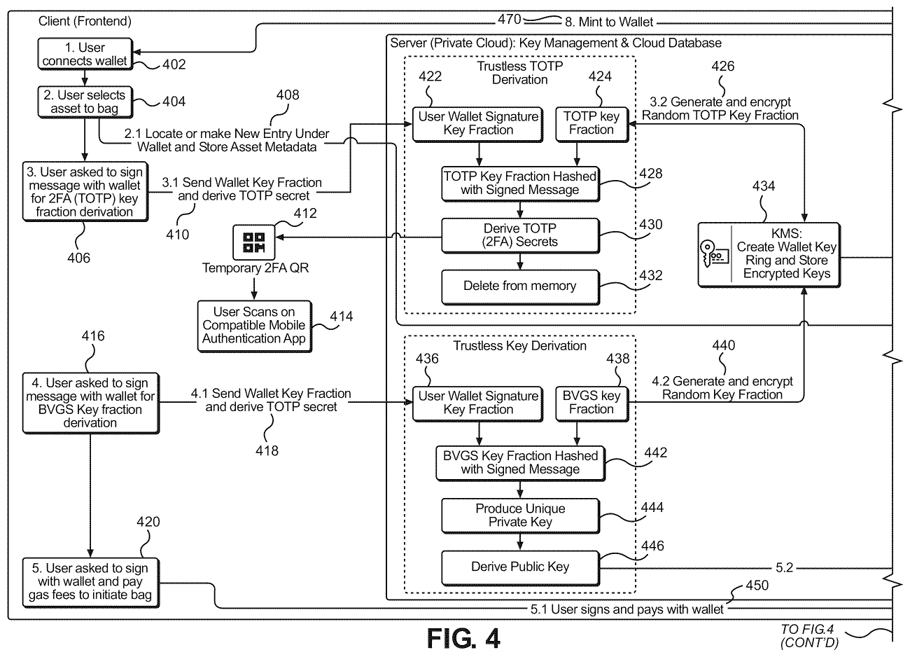

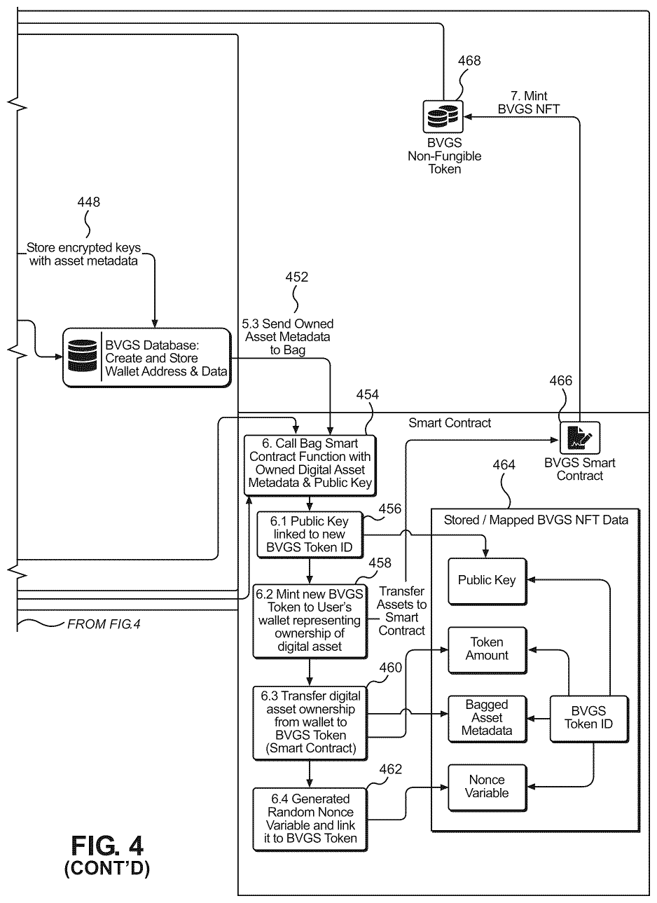

FIGS. 4 and 4 (CONT'D) are partial flow diagrams intended to be interpreted together as one larger drawing, illustrating various interactions between system components for minting a bag NFT according to one or more embodiments herein.

FIGS. 4 and 4 (CONT'D) illustrate an example method for generating a bag NFT representing ownership of a blockchain asset. The example method can be performed by components of the system shown in FIG. 1, for example, such as the user device 110, BVGS cloud server 120, cloud key management service 130, and blockchain 140. The element numbers in FIGS. 4 and 4 (CONT'D) are not intended to indicate that particular stages must be performed in any certain order.

At stage 402, a user can connect their wallet to the BVGS client/frontend 112. This can involve the user selecting an option to connect their blockchain wallet through a user interface provided by the client/frontend 112, such as in a mobile application or web browser executing on the user device.

At stage 404, the user can select an asset to bag. In some examples, the asset can be any asset capable of being stored in a blockchain-based wallet. This can include NFTs, cryptocurrencies, digital collectibles, tokenized assets, or any other asset capable of being stored in such a wallet. Stage 404 can include the user selecting an asset using the interface provided by the client/frontend 112, for example.

At stage 408, the system can locate or create a new user wallet entry in the asset metadata service. For example, the BVGS cloud server 120 can check if an entry already exists for the connected wallet address in the BVGS database 122. If not, a new entry can be created to store metadata associated with that wallet. Alternatively, since bagged asset metadata is inherently stored within the blockchain and tracked with the BVGS smart contract, bagged asset metadata can be instead be retrieved on-chain through smart contract enforced token ownership validation, removing the need to store bagged asset metadata within a cloud database. The smart contract will verify token ownership from the message caller before retrieving on-chain stored bagged asset metadata.

At stage 406, the user can be asked to sign a message with their wallet for purposes of key fraction derivation for a TOTP. This signature can be used to derive cryptographic secrets in a trustless manner. For example, the client/frontend 112 can prompt the user to sign a predetermined message using their wallet's private key.

At stage 410, the wallet key fraction can be sent to the server under a transaction message to derive a TOTP secret. For example, the signed message from stage 406 can be sent to the BVGS cloud server 120 to be used in generating a TOTP secret in a trustless manner, as described in more detail below.

Regarding trustless TOTP derivation, the server can obtain the user wallet signature key fraction at stage 422, as well as a TOTP key fraction at stage 424. In this example, the TOTP key fraction is randomly generated at stage 426, and also encrypted and stored in a key management service at stage 434.

Using the signature key fraction from stage 422 and the TOTP key fraction from stage 424, the server can hash the TOTP key fraction with the signature key fraction at stage 428, using an appropriate hashing function. The server can use the result to derive a TOTP secret at stage 430. Before deleting the derived TOTP secret from memory at stage 432, the server can provide the secret to the user via a temporary code, such as a two-factor authentication (“2FA”) QR code at stage 412. The QR code can be displayed to the user through the client/frontend 112.

At stage 414, the user can scan the QR code on their mobile authentication app. For example, the user can use an authenticator app on their smartphone to scan the displayed QR code and set up 2FA.

At stage 416, the user can be asked to sign a message with the wallet connected at stage 402, and a wallet signature key fraction can be provided to the server at stage 418. The server can also generate a random key fraction, also referred to herein as a BVGS key fraction, at stage 440. This stage can also include encrypting the BVGS key fraction and storing it in a key management service at stage 434.

The server can perform a trustless key derivation based on the user wallet signature key fraction received at stage 436 and the BVGS key fraction received at stage 438. For example, the server can hash the BVGS key fraction with the signed message at stage 442 using any suitable hashing function. The server can thereby produce a unique private key at stage 444 and derive a public key from the private key at stage 446.

At stage 420, the user can sign a blockchain transaction message with their wallet and pay gas fees, which are fees required by the blockchain to perform certain requested actions. This stage can include sending a blockchain transaction to create the bag NFT at stage 450.

FIG. 4 (CONT'D) illustrates additional stages in the method starting in FIG. 4, for generating a bag NFT. At stage 448, the wallet address and asset metadata, which can include encrypted key fractions and metadata describing the asset or assets being wrapped in the bag NFT, are stored in a BVGS database while encrypted versions of some or all of this data can be stored in the key management service. The asset metadata can be provided to the smart contract at stage 452. Alternatively, since bagged asset metadata is inherently stored within the blockchain and tracked with the BVGS smart contract, bagged asset metadata can be instead be retrieved on-chain through smart contract enforced token ownership validation, removing the need to store bagged asset metadata describing the asset or assets being wrapped in the bag NFT within a cloud database.

Stage 454 of the example method can include calling, by the BVGS server, a bagging smart contract function. In some examples, this stage can also include deploying the smart contract on the blockchain. In examples where the smart contract is already deployed, this stage includes making a call to that deployed smart contract. The call at stage 454 can include providing, or otherwise using, the public key derived at stage 446, the user message generated at stages 420 and 450, and the asset metadata stored at stage 448. This call can initiate the on-chain portion of the bagging process, in an example.

At stage 456, the smart contract can link the public key to a new BVGS token ID on chain. This associates various data associated with the bag NFT, such as cryptographic keys or metadata describing the blockchain asset, with the bag NFT itself.

At stage 458, the smart contract can transfer the blockchain asset to the BVGS smart contract at stage 466.

At stage 460, ownership of the digital asset can be transferred from the user's wallet to the bag NFT (controlled by the smart contract). This locks the asset into the bag. The ownership of the blockchain asset remains with the smart contract until it is unbagged in a separate process, described later.

At stage 462, a random nonce variable can be generated by the smart contract and linked to the bag NFT. This nonce variable helps prevent replay attacks in future transactions involving the bag NFT, as the nonce variable can be replaced with each transaction.

Additionally, as part of some or all of stages 454-462, a new BVGS token can be minted to the user's wallet, representing ownership of the bagged digital asset, at stage 468. This token is the bag NFT described previously and herein. The smart contract can store mapped bag NFT data at stage 464, including data mapping a BVGS token ID to the public key, token amount, bagged asset metadata, and nonce variable described.

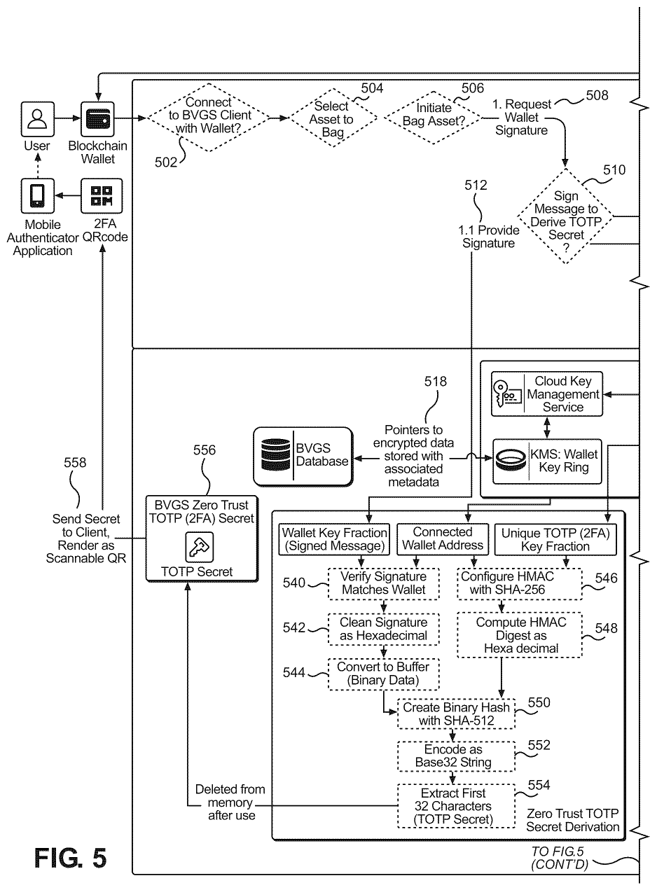

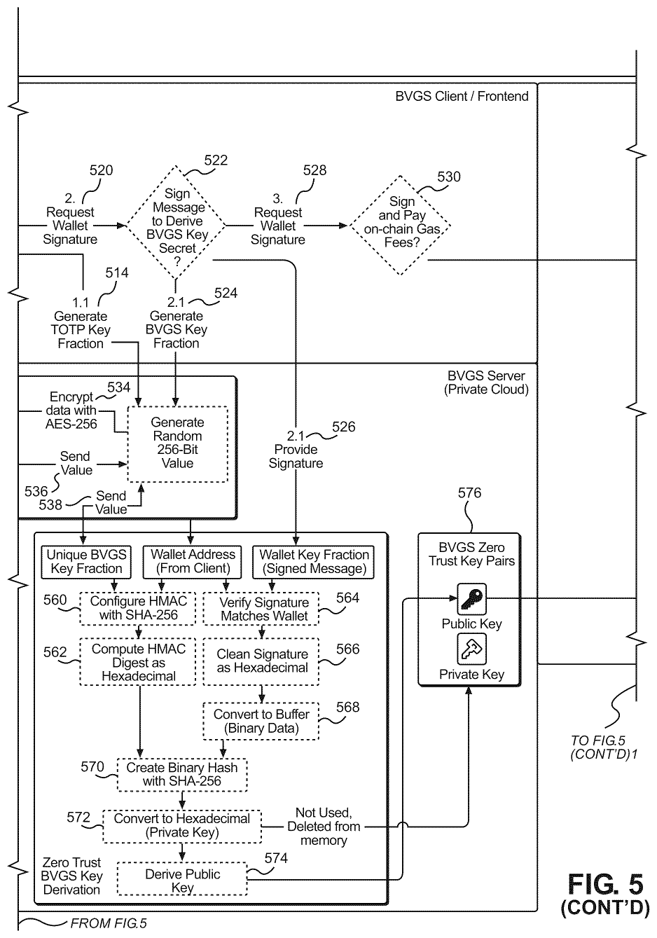

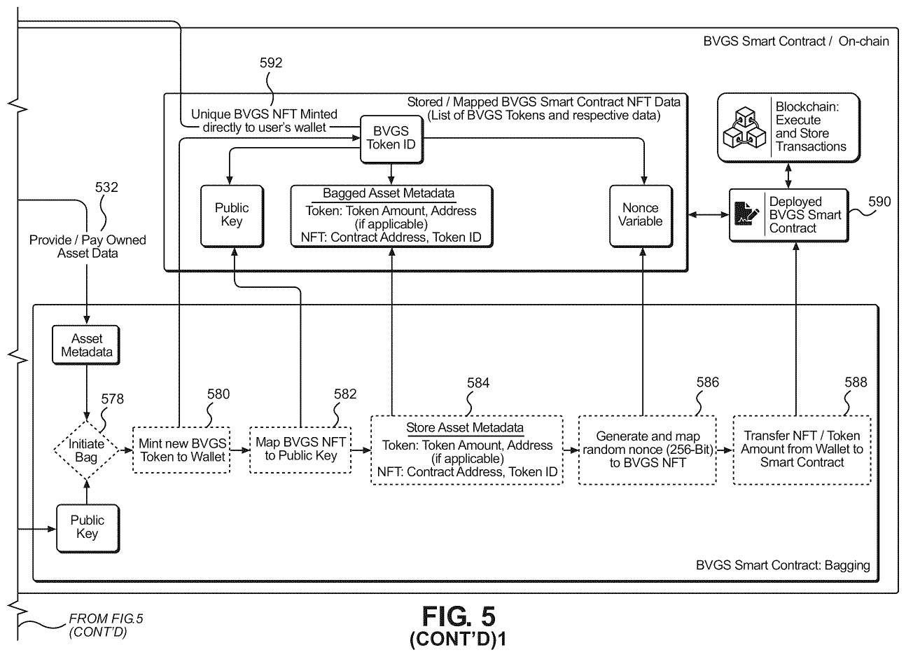

FIG. 5 illustrates a portion of an example process flow for bagging a blockchain asset, with the example flow extending to FIG. 5 (CONT'D) and FIG. 5 (CONT'D)1. The process may begin when a user connects their blockchain wallet to the BVGS client, as shown at stage 502. At stage 504, the user can select an asset within the wallet to bag. The user can then initiate the bagging process at stage 506. Stages 502, 504, and 506 can be performed based on the user interacting with a client frontend, such as a mobile application or web application.

At stages 508 and 510, the system may request a wallet signature for purposes of deriving a TOTP secret. In response, at 512, the user may sign a message, which provides a wallet key fraction within the signed message to the server.

Turning briefly to FIG. 5 (CONT'D), the message signed in stage 512 can be used to generate a TOTP key fraction at stage 514. In this example, the TOTP key fraction is generated based on a random 256-bit value which can be encrypted and stored in a cloud key management service at stage 534. As shown in FIG. 5, the cloud key management service can include a wallet key ring that associates various pieces of data with a specific wallet. The cloud key management service can also store the wallet address of the user.

To generate the BVGS zero trust TOTP (2FA) secret, the system may perform several cryptographic operations shown in FIG. 5. The server can use the wallet key fraction from stage 512, the user's wallet address, and a unique TOTP key fraction randomly generated by the server at stage 536. Using these inputs, the server can verify that the signature matches the wallet at stage 540, format the signature as hexadecimal at stage 542, and convert to binary data at stage 544. This can provide a first input for the TOTP secret.

For a second input for the TOTP secret, the server can use the wallet address and unique TOTP key fraction to configure a hash-based message authentication code (“HMAC”) with a hashing function, such as SHA-256, at stage 546. The server can then compute a HMAC digest as hexadecimal at stage 548 to obtain the second input.

Using the first and second inputs, the server can create a binary hash with a hash function such as SHA-512 at stage 550, encode the result as a base32 string at stage 552, and extract the first 32 characters at stage 554 as the TOTP secret. The server then has the TOTP secret at stage 556, which is sent to the client at stage 558 as a computer-readable code such as a scannable QR code. The TOTP secret is deleted from the server's memory after use.

Turning to FIG. 5 (CONT'D) again, at stage 520 the frontend can request a wallet signature from the user's wallet, which can be either the same signature provided earlier in the method or a new signature. The signature at stage 522 can be provided to the server at stage 526, and can also prompt the server to generate a BVGS key fraction having a random 256-bit value. The server can then use the unique BVGS key fraction at stage 538, along with the wallet address and the wallet key fraction from the signed message, to perform a zero trust BVGS key derivation.

For example, the server can use the unique BVGS key fraction and the wallet address to configure an HMAC with a hashing function such as SHA-256 at stage 560, and compute the HMAC digest as hexadecimal at stage 562. Separately, the server can use the wallet address and the wallet key fraction to verify that the signature matches the wallet at stage 564, clean the signature as hexadecimal at stage 566, and convert the result to binary data at stage 568. Using the outputs from stages 562 and 568, the server can then create a binary hash using a hashing function such as SHA-256 at stage 570, and convert to hexadecimal at stage 572 to obtain the BVGS private key. The private key is then used at stage 574 to derive a BVGS public key. At stage 576, these keys are generated and sent to the blockchain. The keys are then deleted from system memory of the server.

Additionally, the user is prompted to sign a transaction message at stage 528, which can include paying on-chain gas fees for the intended transaction at stage 530. The smart contract receives the relevant asset data via stage 532 as shown, and also receives the BVGS public key generated earlier in the method. The smart contract then performs its own method as shown in FIG. 5 (CONT'D)1.

For example, the smart contract can initiate the bagging process at stage 578. At stage 580, the a new BVGS token (also referred to as a bag NFT or BVGS NFT) is minted to the user's wallet. At stage 582, the BVGS NFT is mapped to the public key. At stage 584, the smart contract stores the asset metadata including a token amount, address, contract address, and/or token ID, depending on the type of asset being bagged.

At stage 586, the smart contract generates and maps a random 256-bit nonce variable to the BVGS NFT. At stage 588, the smart contract transfers the blockchain asset from the wallet to the smart contract, which retains ownership until an unbagging process is performed. The blockchain can be configured to store the mapped BVGS smart contract NFT data, which can include a list of BVGS NFTs and their respective data, including token IDs, bagged asset metadata, nonce variables, and public keys. The BVGS NFT is minted directly to the user's wallet as shown by stage 592. BVGS NFT data such as bagged asset metadata, nonce variables, and public keys can be viewed on-chain through smart contract enforced token ownership validation. Only BVGS NFT owners can view their own NFT data such as bagged asset metadata, nonce variables, and public keys.

In an example, the BVGS smart contract may be executed by a blockchain node. The blockchain node can include one or more processors and memory storing instructions that, when executed by the one or more processors, cause the blockchain node to perform the on-chain operations described above.

In another example, the server-side operations may be performed by a cloud server. The cloud server may include one or more processors and memory storing instructions that, when executed by the one or more processors, cause the cloud server to perform the cryptographic operations and key management functions described above.

In yet another example, the client-side operations may be performed by a user device such as a smartphone or personal computer. The user device may include one or more processors and memory storing instructions that, when executed by the one or more processors, cause the user device to perform the wallet connection, asset selection, and signature operations described above.

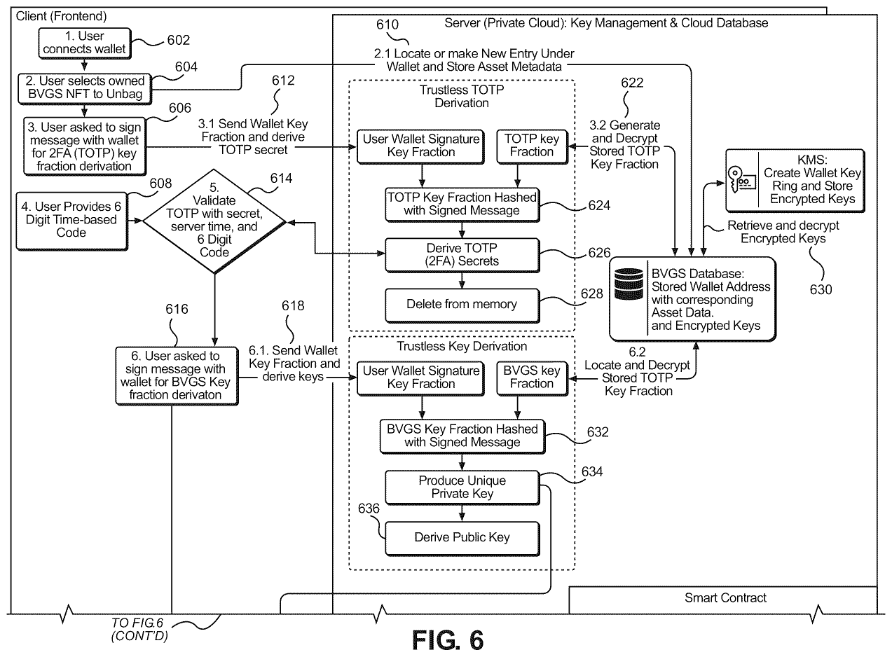

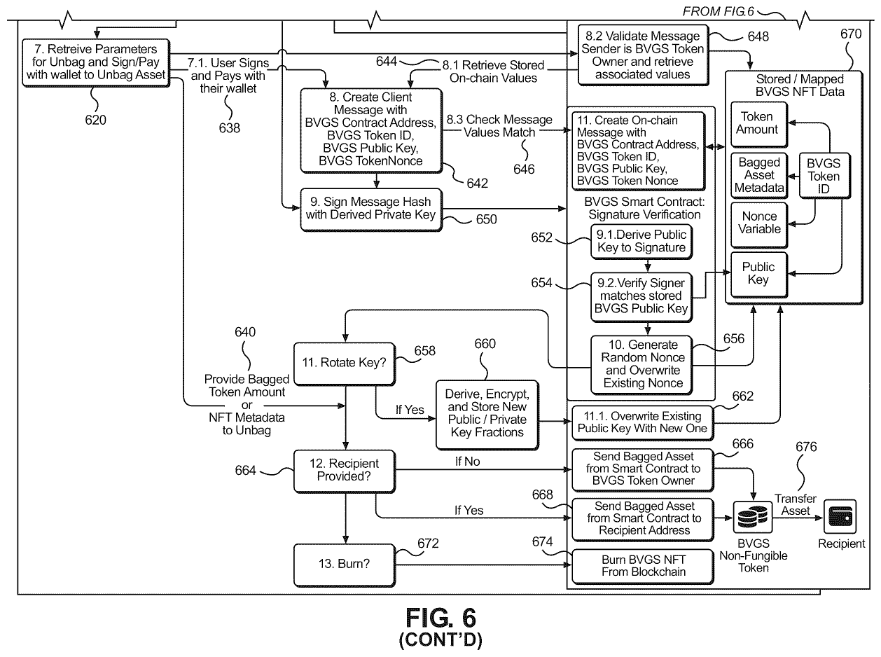

FIGS. 6 and 6 (CONT'D) provide an example flow diagram illustrating interactions between system components for unbagging a blockchain asset according to one or more embodiments herein. Turning first to FIG. 6, an example method can include stages performed by both a client device (e.g., user device 110 in FIG. 1) and a server system (e.g., BVGS cloud server 120 in FIG. 1). The numbered elements are not necessarily numbered or described in sequential order herein.

At stage 602, a user connects their blockchain wallet to the client device. This can involve launching a wallet application or browser extension and authorizing the connection to the BVGS system. At stage 604, the user selects an owned bag NFT (also referred to interchangeably as a BVGS NFT) to unbag. The client device may display a list of one or more BVGS NFTs owned by the connected wallet for the user to choose from. At stage 610, the server locates or creates a new entry for the user's wallet and stores associated asset metadata. This stage ensures that the server has up-to-date information about the user's BVGS NFTs and their underlying assets.

At stage 606, the user is prompted to sign a message with their wallet for two-factor authentication (2FA) key fraction derivation. This signed message will be used as part of the process to generate a time-based one-time password (TOTP) secret. At stage 612, the user's device sends the wallet key fraction (signed message) to the server for purposes of using it to derive the TOTP secret.

At stage 608, the user provides a code, such as a 6-digit, time-based code. This code is typically generated by a mobile authenticator application that the user has previously set up with the BVGS system, using the stored TOTP secret. At stage 614, the code provided by the frontend device can be validated based on the server deriving the TOTP secret.

To derive the TOTP secret, the server can perform a trustless TOTP derivation process. For example, it can use the user wallet signature key fraction obtained at stage 612 and a TOTP key fraction retrieved and decrypted at stage 622. The server can hash the TOTP key fraction with the signed message at stage 624 to derive the TOTP secret at stage 626. After validation, the TOTP secret is deleted from the server memory at stage 628.

At stage 616, the user is asked to sign another message with their wallet for BVGS key fraction derivation. This signed message will be used to generate the cryptographic keys associated with the BVGS NFT. At stage 618, the client sends the wallet key fraction to the server, which uses it to obtain private and public keys corresponding to the BVGS NFT.

The server can perform a trustless key derivation based on the user wallet signature key fraction and a BVGS key fraction. The BVGS key fraction can be retrieved, in an encrypted form, from the database as indicated by stage 6.2. The database, in turn, can retrieve stored encrypted keys from a key management service at stage 630. The server can hash the BVGS key fraction with the signed message at stage 632 to produce a unique private key at stage 634. The private key can be used to derive a public key at stage 636.

The method continues in FIG. 6 (CONT'D) with additional stages for completing the unbagging process and interacting with the blockchain smart contract. Continuing from FIG. 6, the methodology for managing interactions between the blockchain smart contract and other components of the system proceeds with additional stages that ensure the integrity and security of the unbagging process.

Stage 620 involves the client device retrieving parameters for the designed unbagging procedure and prompting the user to sign the transaction and pay to unbag the asset. For example, the user can be required to pay transaction fees, such as gas fees, for the relevant blockchain housing the smart contract. When the user signs and pays with their wallet at stage 638, a message can be created at stage 642 with various information regarding the transaction. This information can include a BVGS contract address, BVGS token ID, BVGS public key, and a nonce value. Some of these items can be retrieved from their on-chain storage location at stage 644.

The message created at stage 642 can be validated by the smart contract at stage 648 to ensure that the sender of the message is the BVGS token owner. As part of this stage, values stored on chain (depicted by element 670) can be retrieved to perform the validation. The message created at stage 642 can also be checked for matching values stored on chain, such as the BVGS contract address, BVGS token ID, BVGS public key, and nonce value. The message can then be signed at stage 650 with a private key derived by the server at stage 634, and the signed message can be provided to the smart contract. The message created at 642 can also include additional parameters such as chain ID, domain, operation type, and operation parameters if adapting to existing signing standards such as EIP-712.

The smart contract can then perform signature verification. At stage 652, the smart contract derives a public key associated with the signature provided at stage 650. The smart contract can also verify that the signer matches the stored BVGS public key at stage 654. The smart contract can then generate a new random nonce variable to overwrite the existing nonce variable.

Next, the method can include determining whether to optionally rotate the key at stage 658 by generating a new key. If so, then the server can derive, encrypt, and store new public and private key fractions at stage 660, and instruct the smart contract to overwrite the existing public key with a new one at stage 662.

The method can proceed to stage 664, where a recipient is potentially identified. This stage can include receiving the bagged token amount or NFT metadata to unbag from the device as indicated by element 640. If a recipient has not been provided, then at stage 666, the smart contract sends the bagged asset from the smart contract to the BVGS token owner. If a recipient has been provided, then at stage 668, the smart contract sends the bagged asset from the smart contract to the provided recipient wallet address. The asset is shown being unbagged and transferred at stage 676.

The stage can also include an option 672 to burn the BVGS NFT such that it may not be reused for other assets. If this option is elected, then the smart contract can be instructed at stage 674 to burn the BVGS NFT from the blockchain.

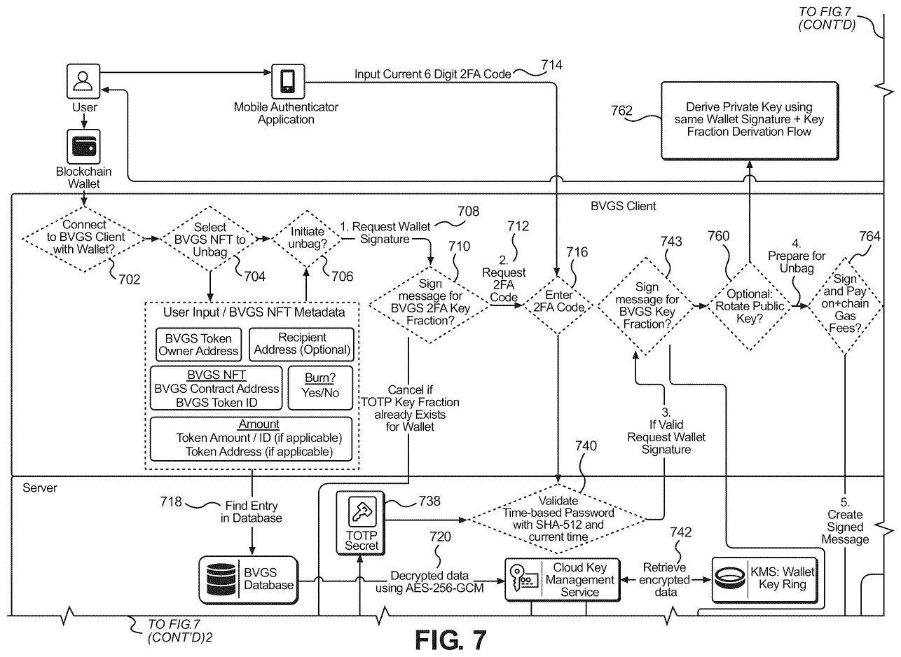

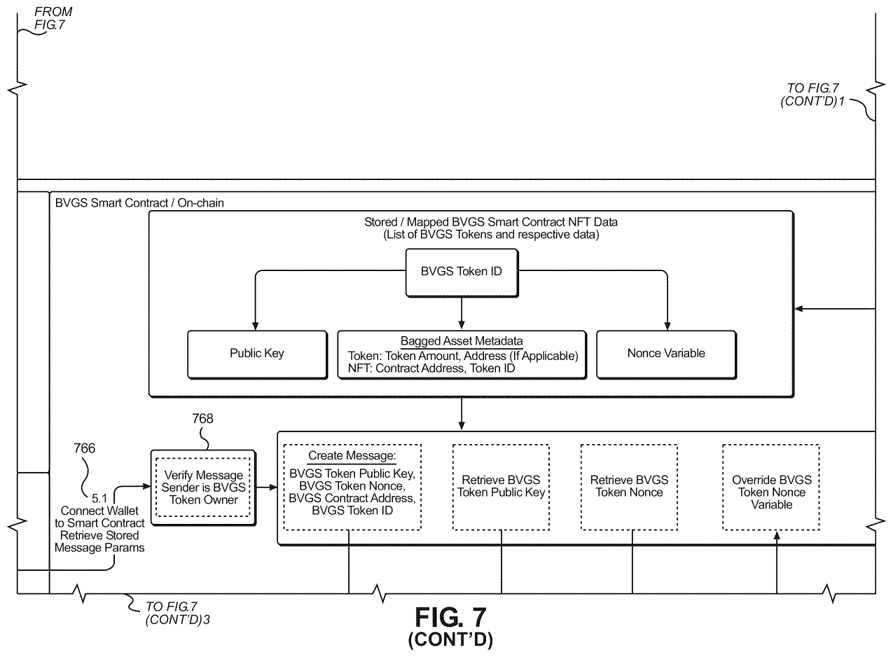

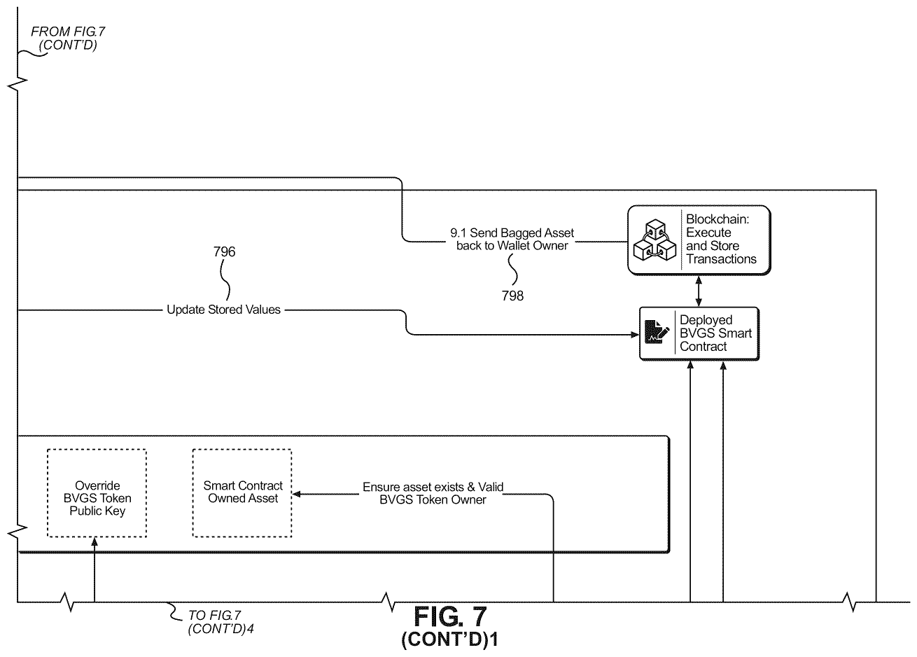

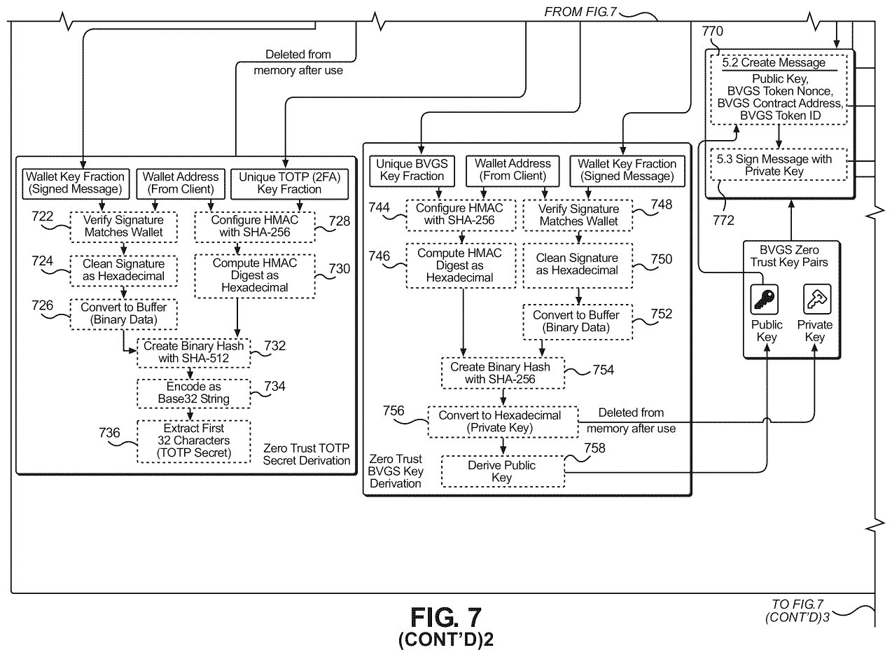

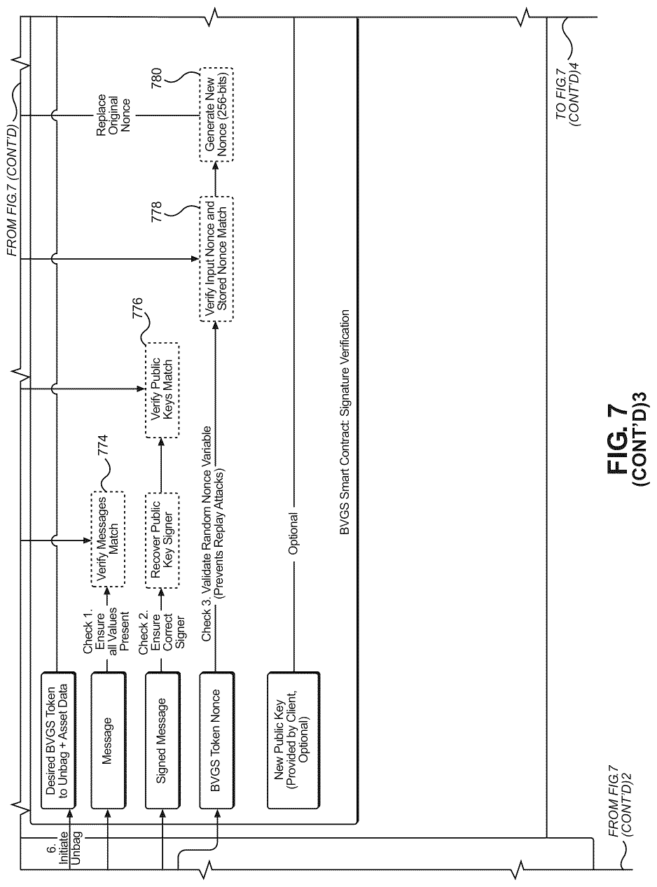

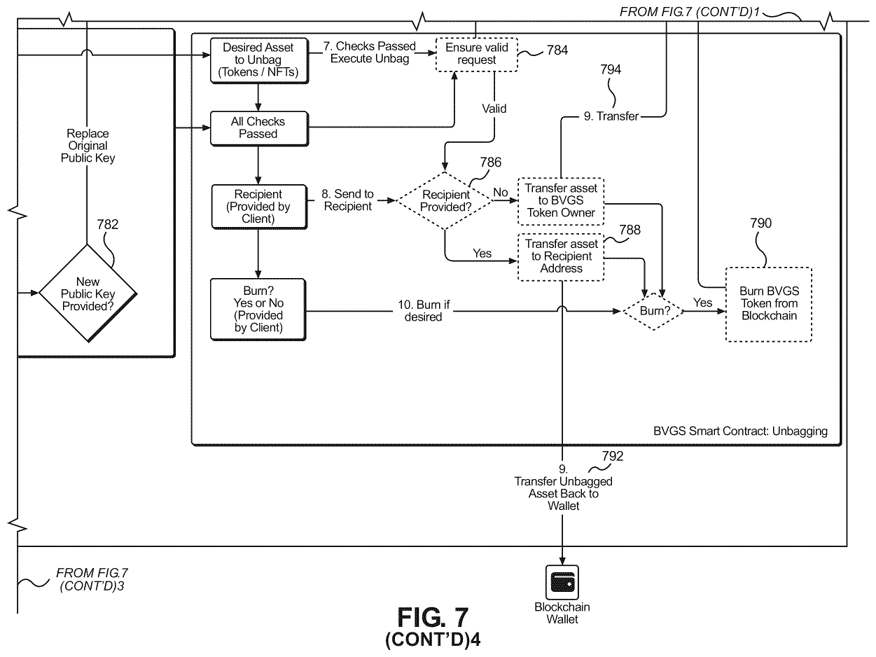

FIGS. 7, 7 (CONT'D), 7 (CONT'D)1, 7 (CONT'D)2, 7 (CONT'D)3, and 7 (CONT'D)4 together provide a flow diagram illustrating interactions between system components for unbagging a blockchain asset according to one or more embodiments herein. These figures are described in conjunction with one another, as the example flow diagram moves between different figures at various locations. Neither the figures nor the numbered elements are necessarily presented or described in sequential order herein.

Turning to stage 702 of FIG. 7, a user can connect their wallet to the BVGS client, such as by using an interface associated with a mobile application or website. The user can then select a BVGS NFT to unbag at stage 704. This can include selecting or providing various options such as a recipient address, a decision on whether to burn the BVGS NFT, and a token amount and address if applicable. This information can be used to locate information pertaining to the BVGS NFT in the server database at stage 718.

Having selected relevant options, the user can be prompted to initiate the unbagging process at stage 706. This can include a request for a wallet signature at stage 708. The user can sign the message at stage 710, for purposes of providing a TOTP key fraction for use in the zero trust TOTP derivation of FIG. 7 (CONT'D)2. At stage 712, the user can be prompted to provide a 2FA code. This code can be obtained through the user's authenticator application, for example, which can use the stored TOTP secret and the current time to provide a code, such as a six-digit 2FA code. The user can receive this code at stage 714 and provide it to the system interface at stage 716.

The server can receive the 2FA code and validate it. The validation process can include, for example, performing a zero trust TOTP secret derivation using a wallet key fraction from the signed message at stage 710, a wallet address used to sign the message, and a unique TOTP key fraction. The TOTP key fraction can be obtained by a cloud key management service at stage 742 from a wallet key ring, decrypted, and used in the TOTP derivation.

With respect to the derivation, at stage 722 the server can verify that the signature matches the wallet address using an appropriate hash function. It can clear the signature as hexadecimal at stage 724 and convert to binary data at stage 726. In parallel, the server can use the wallet address and TOTP key fraction as inputs to configure HMAC with a hashing function at stage 728, such as SHA-256, and compute an HMAC digest as hexadecimal at stage 730. Using the outputs of these parallel processes, the server can create a binary hash with a hash function at stage 732, encode the result as a Base32 string at stage 734, and extract the first 32 characters at stage 736 to obtain the TOTP secret depicted by element 738.

The TOTP secret 738 can then be used to validate a 2FA code entered by the user at stage 716, as described above. If the code is valid, the server can request a wallet signature for purposes of obtaining a BVGS key fraction. The user can be prompted to sign that message at stage 743. This information can then be used by the server to perform a zero trust BVGS key derivation as shown in FIG. 7 (CONT'D)2.

In more detail, at stage 744 the server can use the unique BVGS key fraction and wallet address to configure HMAC with a hashing function, such as SHA-256. The output can be used to compute a HMAC digest as hexadecimal at stage 746, as shown. Additionally, at stage 748, the server can use the wallet address and wallet key fraction from the signed message at stage 743 in order to verify that the signature matches the wallet. This can include applying one or more hashing functions using these inputs. The output of the function(s) can then be cleaned as a hexadecimal at stage 750 and converted to a buffer consisting of binary data at stage 750. Using the outputs from stages 746 and 752, at stage 754 the server can create a binary hash using a hashing function such as SHA-256. The output of this stage can be converted to hexadecimal at stage 756 to obtain a private key corresponding to the BVGS NFT. The key can be used to sign a message at stage 772 and then deleted from the server's memory after use. Before deletion, the server can also use the private key to derive a public key at stage 758.

Turning back to FIG. 7, after signing the message at stage 743, the user can be prompted to optionally rotate the public key. If the user selects this option, then stage 762 can include deriving the private key using the same wallet signature and key fraction derivation procedures described above, and the resulting key can be replaced with a new one at the appropriate stage of the method.

When the user is ready to unbag their blockchain asset, they can sign a message and pay for any fees at stage 764. This creates a signed message shown at stage 770 of FIG. 7 (CONT'D)2. As shown, the signed message can include information such as the public key, BVGS token nonce, BVGS contract address, and BVGS token ID. The public key can be derived using the example methods described above.

Turning next to on-chain stages, FIG. 7 (CONT'D) and 7 (CONT'D)3 are discussed in tandem herein. At stage 766, the wallet can connect to the smart contract and stored message parameters can be received. At stage 768, the smart contract can verify that the message sender matches the BVGS token owner as stored on the blockchain.

The smart contract can also perform a signature verification procedure that compares various pieces of information received from the server with information stored on the blockchain. For example, stage 774 can include verifying that the message received from the server on behalf of the user matches a message created by the smart contract. Stage 776 can include the smart contract verifying that public keys match. This can be performed by extracting the public key from the signer of the signed message and retrieving the BVGS public key from the blockchain for the comparison. Stage 778 can include verifying that the input nonce and stored nonce match. This can include extracting the BVGS token nonce from the signed message from the server and comparing it to the BVGS token nonce retrieved from the blockchain. In some examples, the system can generate a new nonce value at stage 780 to replace the old one at stage 780. Rotating the nonce value helps prevent replay attacks and provides heightened security. In other examples, the system can include additional message information such as chain ID, domain, operation type, and operation parameters which prevents cross-chain and operation-level signature replay attacks and can add more specificity and uniqueness to the message created. Optionally, a new public key can be provided at stage 782 and used to override the BVGS token public key stored on chain.

Having passed all relevant checks, the smart contract can perform an unbagging process shown mostly in FIG. 7 (CONT'D)4. This process can include, at stage 784, ensuring that the request to unbag the blockchain asset has passed all relevant checks. It can also include determining the recipient at stage 786. If a particular recipient has not been provided, then the asset can be transferred to the owner of the BVGS NFT as shown by stages 794 and 798. If a particular recipient has been provided, then the asset can be transferred to the wallet associated with that recipient as shown by stages 788 and 792. The unbagging process can also determine whether the user has requested the BVGS NFT to be burned, in which case the smart contract can burn the BVGS token from the blockchain at 790 by sending it to a random, unrecoverable wallet address. As part of the unbagging process, the smart contract can update values stored on chain at stage 796, including updating values corresponding to the BVGS token ID, public key, bagged asset metadata, and nonce variable, to the extent these values had not already been updated on chain.

The systems and methods disclosed herein provide several benefits and advantages over existing blockchain asset management solutions. By implementing trustless two-factor authentication and cryptographic key splitting, the system enhances security while maintaining a user-friendly experience. There are many potential benefits.

For example, the disclosed systems and methods can provide enhanced security. The dual-layer security approach requiring both NFT ownership and a valid BVGS key signature significantly reduces the risk of unauthorized access. Even if an attacker compromises a user's wallet private key, they cannot withdraw assets from a BVGS bag without also obtaining the separate BVGS private key. This multi-factor approach provides robust protection against common attack vectors.

Another example benefit of the disclosed systems and methods is its trustless design. BVGS eliminates single points of failure by splitting custody between the blockchain and an external key management system. No single entity, including the BVGS system operators, can unilaterally access or transfer bagged assets. All critical operations require cryptographic proofs and on-chain verification, ensuring a truly trustless architecture.

Yet another example benefit of the disclosed systems and methods is its simplified asset management. Users can securely store and manage multiple types of blockchain assets, including native cryptocurrencies, fungible tokens, and non-fungible tokens (NFTs), within a single BVGS NFT container. This unified approach streamlines custody and reduces the complexity of managing diverse digital assets.

A further example benefit of the disclosed systems and methods is flexible key management. The BVGS system allows for optional key rotation, enabling users to update their BVGS public key if they suspect compromise or simply want to refresh their cryptographic credentials. This feature enhances long-term security and adaptability.

Another example benefit of the disclosed systems and methods is replay attack prevention. By implementing nonce variables that are updated after each successful operation, BVGS prevents replay attacks where an attacker might attempt to reuse a valid signature from a previous transaction. This ensures that each cryptographic authorization is single-use and time-bound. Since additional message parameters can be added to signatures such as chain ID, domain, operation type, and operation parameters, BVGS prevents cross-chain and operation-level replay attacks, where an attacker might attempt to reuse a valid signature for a different transaction on another chain or operation.

An additional example benefit of the disclosed systems and methods is that they are wallet agnostic. The BVGS system can integrate with various types of blockchain wallets, including hardware wallets, software wallets, and mobile wallets. This flexibility allows users to leverage their preferred wallet solutions while benefiting from the enhanced security of BVGS. At the same time, the system is asset specific, meaning a wallet can maintain separate assets that are not bagged, alongside a BVGS NFT corresponding to a bagged asset.

A further example benefit of the disclosed systems and methods is its quantum resistance. While current cryptographic standards remain secure against classical computing threats, the disclosed split-key approach and ability to rotate keys provide a foundation for implementing quantum-resistant algorithms in the future. The system's modular design allows for upgrading cryptographic primitives as new standards emerge.

An additional example benefit of the disclosed systems and methods is asset custody. Individual users can create BVGS NFTs to secure their high-value digital assets, protecting them against potential wallet compromises or phishing attacks. Similarly, financial institutions and cryptocurrency exchanges can leverage the BVGS system to implement robust custody solutions for client assets. The multi-factor security model, as well as the ability for the BVGS system to operate on-premise through edge servers or server rack deployments, aligns with regulatory requirements and best practices for institutional-grade asset management.

Other examples of the disclosure will be apparent to those skilled in the art from consideration of the specification and practice of the examples disclosed herein. Though some of the described methods have been presented as a series of stages, it should be appreciated that one or more stages can occur simultaneously, in an overlapping fashion, or in a different order. The order of stages presented are only illustrative of the possibilities and those stages can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for trustless management of a blockchain asset, comprising:
receiving a user selection of a blockchain asset in a wallet;
receiving a wallet signature key fraction associated with the wallet;
generating a random time-based, one-time password (TOTP) key fraction;
generating a TOTP secret based on the wallet signature key fraction and the TOTP key fraction;
transmitting the TOTP secret to a user device of the user;
generating a random key fraction;
generating a public-private key pair based on the wallet signature and the random key fraction;
invoking a smart contract on a blockchain, wherein invoking causes the smart contract to:
mint a bag non-fungible token (NFT) to the wallet, wherein the bag NFT represents ownership of the blockchain asset;
generate a random nonce variable; and
generate a bag NFT ID, wherein the bag NFT ID is mapped to a public key of the public-private key pair and a random nonce variable.

2. The method of claim 1, wherein transmitting the TOTP secret to the user device is performed by causing the user device to use a temporary QR code that contains the TOTP secret.

3. The method of claim 1, wherein the wallet signature key fraction is produced by signing a message with the wallet private key.

4. The method of claim 1, further comprising deleting the TOTP secret and wallet signature key fraction from system memory after transmitting them to the user device.

5. The method of claim 1, further comprising encrypting and storing the TOTP key fraction in a key management service.

6. The method of claim 1, wherein the bag NFT ID is also mapped to a token amount corresponding to the blockchain asset.

7. The method of claim 1, wherein the bag NFT ID is also mapped to asset metadata.

8. The method of claim 1, wherein the smart contract generates and stores the bag NFT ID on the blockchain.

9. The method of claim 1, wherein generating the TOTP secret based on the wallet signature key fraction and the TOTP key fraction further comprises creating a binary hash using a hashing function.

10. The method of claim 1, further comprising:
receiving a request to unbag the blockchain asset using the bag NFT;
receiving a wallet signature key fraction associated with the wallet;
decrypting the TOTP key fraction associated with the wallet;
generating the TOTP secret using the wallet signature key fraction and the decrypted TOTP key fraction;
validating, using the new TOTP secret, a code provided by the user;
decrypting the key fraction associated with the bag NFT ID;
generating a private key from the public-private key pair based on the wallet signature key fraction and stored random key fraction;
generating a message that includes the bag NFT ID, public key, and the random nonce variable;
signing the generated message using the private key;
invoking the smart contract on a blockchain, wherein invoking causes the smart contract to:
validate that the message originates from the owner of the bag NFT;
verify the signed message;
unbag the blockchain asset from the bag NFT; and
send the blockchain asset to a recipient.

11. The method of claim 10, wherein the smart contract generates a new random nonce variable to overwrite the random nonce variable.

12. The method of claim 10, wherein a key management service performs a key rotation by generating a new public-private key pair based on the wallet signature key fraction and a new random key fraction.

13. The method of claim 10, wherein the smart contract performs a key rotation by overwriting the original public key mapped to the bag NFT.

14. The method of claim 9, further comprising burning the bag NFT.

15. The method of claim 9, wherein sending the blockchain asset to a recipient comprises sending the blockchain asset to the user's wallet.

16. The method of claim 9, wherein sending the blockchain asset to a recipient comprises sending the blockchain asset to a new recipient identified by the user.

17. A server system comprising:
a hardware-based processor; and
a memory storing non-transitory, computer-readable instructions that, when executed by the processor, causes the server system to:
generate a random time-based, one-time password (TOTP) key fraction;
generate a TOTP secret based on the wallet signature key fraction and the TOTP key fraction;
transmit the TOTP secret to a user device of the user;
generate a random key fraction;
generate a public-private key pair based on the wallet signature and the random key fraction;
invoke a smart contract on a blockchain, wherein invoking causes the smart contract to:
mint a bag non-fungible token (NFT) to the wallet, wherein the bag NFT represents ownership of the blockchain asset; and
generate a bag NFT ID, wherein the bag NFT ID is mapped to a public key of the public-private key pair and a random nonce variable.

18. The server system of claim 17, wherein the instructions further cause the server system to:
validate a user code with the TOTP secret;
decrypt a stored random key fraction;
invoke the smart contract, wherein invoking causes the smart contract to:
locate the bag NFT within the wallet;
validate the invoker is valid; and
transfer the blockchain asset associated with the bag NFT to a recipient.

19. A method for trustless management of a blockchain asset, comprising:
receiving, by a server, a request from a user device to transmit the blockchain asset to a recipient address, the request including an identification of a bag non-fungible token (NFT) associated with the blockchain asset;
validating the request based on receiving a two-factor authentication (2FA) code associated with a TOTP secret;
receiving, by the server, a wallet signature from a wallet associated with the blockchain asset;
generating a private key associated with the bag NFT based on a stored key fraction, a wallet address, and the wallet signature;
deriving a public key associated with the private key and bag NFT;
generating a message that includes the public key, a nonce variable associated with the bag NFT, and a token ID associated with the bag NFT;
signing the generated message with the private key; and
invoking a smart contract on a blockchain, wherein invoking causes the smart contract to:
verify that an invoker owns the bag NFT;
verify the signed, generated message; and
cause the blockchain to transfer the blockchain asset to the recipient address.

20. The method of claim 19, wherein verifying the signed, generated message further comprises:
verifying that a wallet message sender matches the bag NFT owner; and
verifying that the message includes a public key associated with the bag NFT, a nonce variable associated with the bag NFT, and a token ID associated with the bag NFT.
